(19) United States
(12) Patent Application Publication
(10) Pub. No.: US 2015/0167376 A1
(43) Pub. Date: Jun. 18, 2015

(54) Storm Panel Retaining Clamps and Methods of Securing Storm Panels Using Same

(71) Applicant: Dan Burgess, Pawleys Island, SC (US)

(72) Inventor: Dan Burgess, Pawleys Island, SC (US)

(21) Appl. No.: 14/565,881

(22) Filed: Dec. 10, 2014

Related U.S. Application Data
(60) Provisional application No. 61/915,027, filed on Dec. 12, 2013.

(51) Int. Cl. E06B 3/30; E04B 1/38; E06B 5/10; F16B 2/10

(52) U.S. Cl. CPC E06B 3/30; F16B 2/10; E04B 1/38; E06B 5/10

(57) ABSTRACT

A clamp for securing a storm panel to a window of a building includes a pair of opposed, first and second elongated, rigid members. Each member has a first end that includes a user gripping portion and a second end, opposite the first end, that includes a jaw portion. The first member has a first length and the second member has a second length that is shorter than the first length. A pivot pin connects the members between the first and second ends thereof, and a biasing element, such as a spring, urges the jaw portions toward each other. The biasing element may develop a minimum torque of about 1.40 lbs. The jaw portion of the first member may include storm panel-gripping teeth, and the jaw portion of the second member has a smooth surface configured to engage the framing (or other structure) of a window without damaging the framing.

### RELATED APPLICATION

This application claims the benefit of and priority to U.S. Provisional Patent Application No. 61/915,027 filed Dec. 12, 2013, the disclosure of which is incorporated herein by reference as if set forth in its entirety.

### FIELD OF THE INVENTION

The present invention relates generally to storm panels for windows of structures, such as buildings and houses and, more particularly, to securing storm panels to such windows.

### BACKGROUND

Currently, when a storm panel is attached to a window, it is done by attaching the storm panel to the window frame or to the siding of the house/building via screws or other fasteners. Not only may this damage the framing and/or siding, but also this may void any warranty on the window and/or siding of the house/building. It would be desirable to be able to install storm panels to windows of houses and buildings without harming the windows or siding and without affecting any warranties associated therewith.

### SUMMARY

It should be appreciated that this Summary is provided to introduce a selection of concepts in a simplified form, the concepts being further described below in the Detailed Description. This Summary is not intended to identify key features or essential features of this disclosure, nor is it intended to limit the scope of the invention.

According to some embodiments of the present invention, a clamp for securing a storm panel to a window of a building includes a pair of opposed, first and second elongated, rigid members. Each member has a first end that includes a user gripping portion and a second end, opposite the first end, that includes a jaw portion. The first member has a first length and the second member has a second length that is shorter than the first length. For example, in some embodiments, the length of the first member is at least twenty five percent (25%) greater than the length of the second member. Stated otherwise, a ratio of the length of the first member to the length of the second member is at least 1.375. In some embodiments, the length of the second member is at least about two inches (2.0 in.) and the length of the first member is at least about two and three-quarters inches (2.75 in.).

A pivot pin connects the members between the first and second ends thereof, and a biasing element, such as a spring, urges the jaw portions toward each other. The biasing element may develop a minimum torque of about 1.40 lbs. In some embodiments, the biasing element is a torsion spring having opposed legs bearing against corresponding inner surfaces of the first ends of the first and second members. In some embodiments, the biasing element is a spring coiled around the pivot pin. The selection of a type of spring will be within one of skill in the art.

The jaw portion of the first member includes a plurality of storm panel-gripping teeth, and the jaw portion of the second member comprises a smooth surface configured to engage the framing (or other structure) of a window without damaging the framing. In some embodiments, the storm panel-gripping teeth are a plurality of parallel, spaced-apart ridges.

In some embodiments, each member has a substantially constant width along its length. For example, in some embodiments, the width of each member is at least about two inches (2.0 in.).

In some embodiments, each member has a substantially rectangular shape with rounded corners.

In some embodiments, the user gripping portion of each member includes a coating of tactile material (e.g., natural rubber, synthetic rubber, and silicone) that facilitates gripping by a user's hand. In other embodiments, the user gripping portions may include grooves or other features to facilitate gripping and operation of the clamp.

In some embodiments, the second member jaw portion comprises a coating of resilient material (e.g., natural rubber, synthetic rubber, and silicone).

In some embodiments, the first and second members are formed from metal, such as galvanized metal.

In some embodiments, a locking member (e.g., a set screw, etc.) is threadingly secured to the jaw portion of the first member and is configured to retain the clamp in an installed position when a storm panel and edge of a window frame are positioned between the jaw portion of the first member and the jaw portion of the second member.

According to some embodiments of the present invention, a method of securing a storm panel to a window of a structure includes covering the window with a storm panel, and clamping the edge portions of the storm panel to a frame of the window with a plurality of clamps. Each clamp includes a pair of opposed, first and second elongated members, each member having a first end including a manually grippable portion and a second end, opposite the first end, including a jaw portion. The first member has a first length and the second member has a second length that is shorter than the first length. A pivot pin connects the members between the first and second ends thereof, and a biasing element urges the jaw portions toward each other. In some embodiments, the jaw portion of the first member includes a plurality of storm panel-gripping teeth, and the jaw portion of the second member comprises a smooth surface. In some embodiments, the first length is at least twenty five percent (25%) greater than the second length. In some embodiments the manually grippable portion of each member includes a coating of tactile material that facilitates gripping by a user's hand and/or the second member jaw portion comprises a coating of resilient material.

According to some embodiments of the present invention, a storm panel retaining clamp includes a rear wall and opposing, elongated first and second side walls extending outwardly from the rear wall in adjacent, spaced-apart relationship. The first wall has a first length and the second wall has a second length that is shorter than the first length. A locking member (e.g., a set screw, etc.) is threadingly secured to the first wall and is configured to retain the clamp in an installed position when a storm panel and edge of a window frame are positioned between the first and second walls. In some embodiments, the first length is at least twenty five percent (25%) greater than the second length.

It is noted that aspects of the invention described with respect to one embodiment may be incorporated in a different embodiment although not specifically described relative thereto. That is, all embodiments and/or features of any embodiment can be combined in any way and/or combination. Applicant reserves the right to change any originally filed claim or file any new claim accordingly, including the right to be able to amend any originally filed claim to depend from and/or incorporate any feature of any other claim although not originally claimed in that manner. These and other objects and/or aspects of the present invention are explained in detail below.

### BRIEF DESCRIPTION OF THE DRAWINGS

The accompanying drawings, which form a part of the specification, illustrate some exemplary embodiments. The drawings and description together serve to fully explain the exemplary embodiments.

FIG. 1 is a cross-sectional side view of a storm panel retaining clamp, according to some embodiments of the present invention.

FIG. 2 is a cross-sectional end view of the storm panel retaining clamp of FIG. 1.

FIG. 3 is a top plan view of the storm panel retaining clamp of FIG. 1.

FIGS. 4 and 5 illustrate the storm panel retaining clamp of FIG. 1 in use securing a storm panel to a window of a house or building.

FIG. 6 is a perspective view of a storm panel retaining clamp, according to some embodiments of the present invention, and illustrating the clamp securing a storm panel to a window of a house or building.

FIGS. 7A and 7B are cross-sectional side views of storm panel retaining clamps, according to some embodiments of the present invention.

FIG. 8 is a cross-sectional side view of a storm panel retaining clamp, according to some embodiments of the present invention.

FIG. 9 is a top plan view of the storm panel retaining clamp of FIG. 8.

### DETAILED DESCRIPTION

The present invention will now be described more fully hereinafter with reference to the accompanying figures, in which embodiments of the invention are shown. This invention may, however, be embodied in many different forms and should not be construed as limited to the embodiments set forth herein. Like numbers refer to like elements throughout. In the figures, certain components or features may be exaggerated for clarity, and broken lines illustrate optional features or elements unless specified otherwise. In addition, the sequence of operations (or steps) is not limited to the order presented in the figures and/or claims unless specifically indicated otherwise. Features described with respect to one figure or embodiment can be associated with another embodiment of figure although not specifically described or shown as such.

It will be understood that when a feature or element is referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

It will be understood that although the terms first and second are used herein to describe various features or elements, these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

As used herein, the terms “comprise”, “comprising”, “comprises”, “include”, “including”, “includes”, “have”, “has”, “having”, or variants thereof, are open-ended, and include one or more stated features, elements, steps, components or functions but does not preclude the presence or addition of one or more other features, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

The term “about”, as used herein with respect to a value or number, means that the value or number can vary by +/−20%, +/−10%, +/−5%, +/−1%, +/−0.5%, or even +/−0.1%.

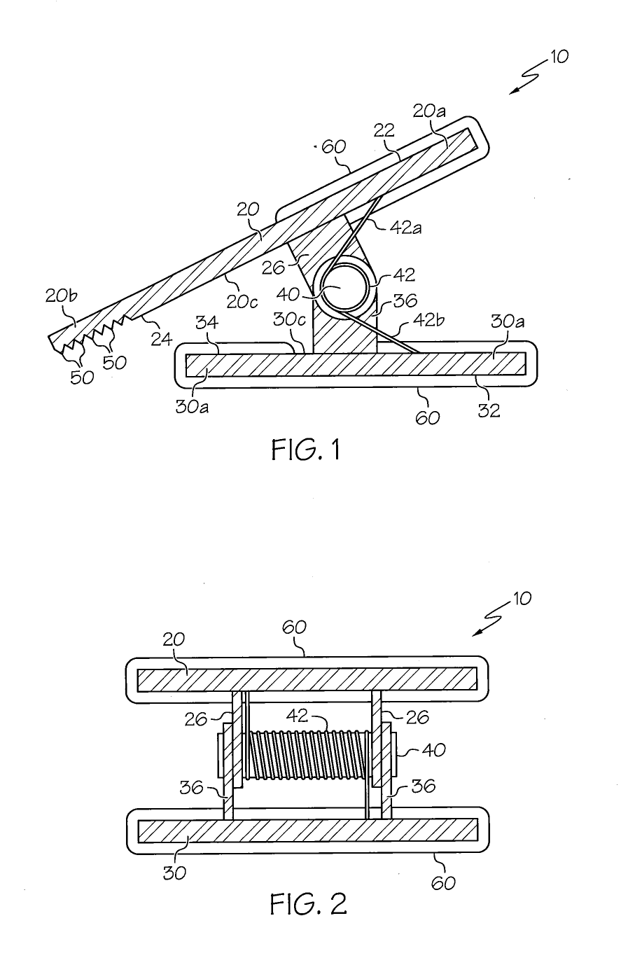

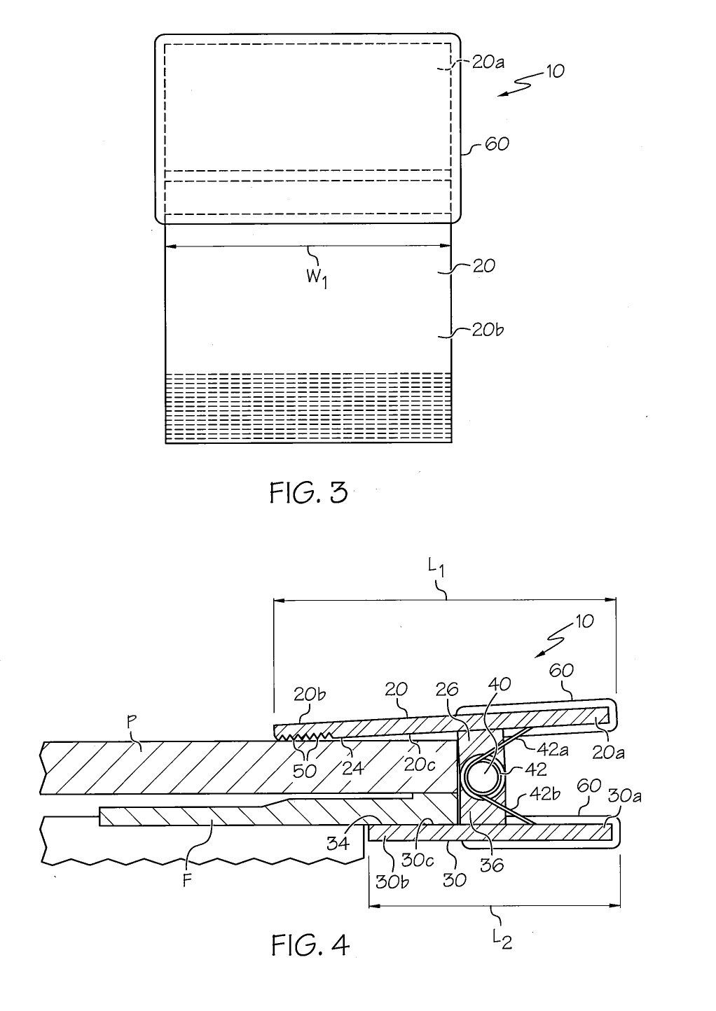

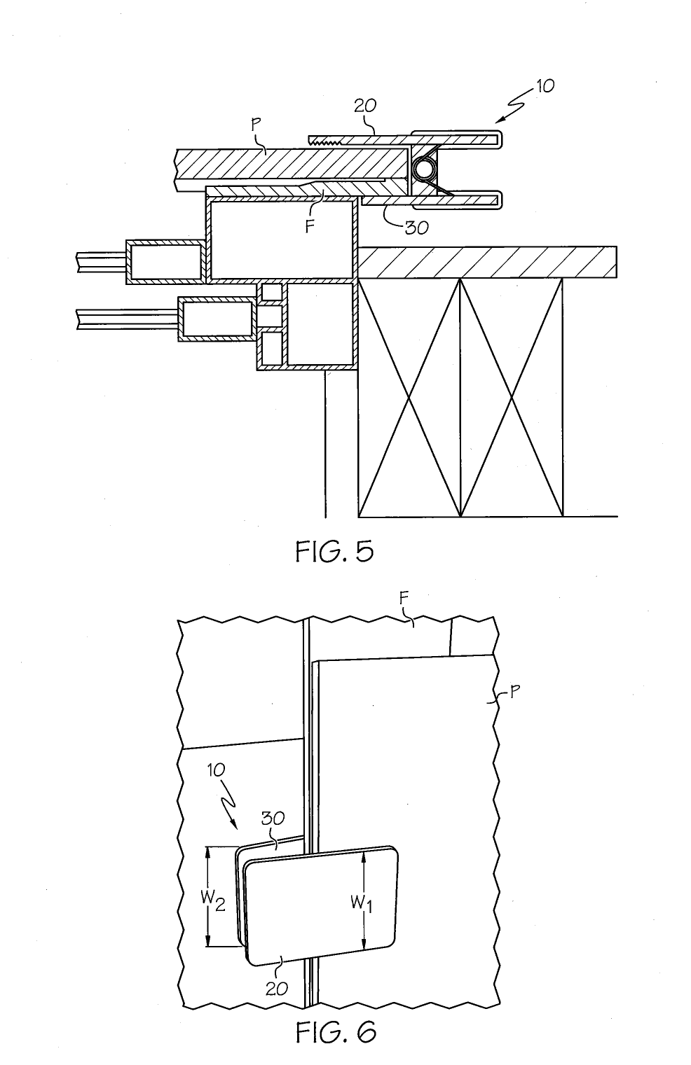

Referring now to FIGS. 1-6, a clamp 10 for securing storm panels (e.g., OSB panels, plywood panels, etc.) to windows of a house or building (e.g., a house or building at the beach), according to some embodiments of the present invention, is illustrated. A plurality of the clamps 10 are used to removably secure a storm panel P to a window of a house/building. Typically, four or more clamps are utilized.

The illustrated clamp 10 includes a pair of opposed, first and second elongated, rigid members 20, 30. Each member 20, 30 has a first end 20a, 30a that includes a user gripping portion 22, 32 and a second end 20b, 30b, opposite the first end 20a, 30a, that includes a jaw portion 24, 34.

The first and second members 20, 30 are pivotally connected to each other at an intermediate location between the first ends 20a, 30a and the second ends 20b, 30b. In the illustrated embodiment, the first member 20 includes a pair of spaced-apart pivot supports 26 extending outwardly from the first member inner surface 20c (FIG. 2). The second member 30 includes a pair of spaced-apart pivot supports 36 extending outwardly from the inner surface 30c (FIG. 2). Each first member pivot support 26 is configured to be positioned in adjacent, contacting relationship with a respective second member pivot support 36, as illustrated in FIG. 2. In the illustrated embodiment, the first member pivot supports 26 are positioned between the second member pivot supports 36. However, embodiments of the present invention are not limited to the illustrated configuration. In other embodiments, the second member pivot supports 36 may be positioned between the first member pivot supports 26. In other embodiments, one of the first member pivot supports 26 may be positioned on one side of a respective second member pivot support 36, and the other first member pivot support 26 may be positioned on an opposite side of the other respective second member pivot support 36, etc.

Each of the pivot supports 26, 36 includes an aperture formed therethrough configured to receive a pivot pin 40. The pivot pin 40 extends through the apertures of the pivot supports 26, 36 when aligned to pivotally connect the first and second members 20, 30 to each other, as would be understood by one skilled in the art. In the illustrated embodiment, a torsion spring 42 is coiled around the pivot pin 40 and has opposed legs 42a, 42b bearing against corresponding inner surfaces 20c, 30c of the first ends 20a, 30a of the first and second members 20, 30. The spring 42 serves as a biasing element to urge the jaw portions 24, 34 toward each other. In some embodiments, the spring 42 may develop a minimum torque of about 1.40 lbs.

However, embodiments of the present invention are not limited to the illustrated spring 42. Various types of biasing elements having various configurations may be utilized. Moreover, embodiments of the present invention are not limited to the illustrated pin connection. Other ways of pivotally connecting the first and second members 20, 30 may be utilized, also.

In the illustrated embodiment, the first member 20 is longer than the second member 30. For example, as illustrated in FIG. 4, the first member 20 has a first length L₁ and the second member 30 has a second length L₂ that is shorter than the first length L₁. In some embodiments, the length L₁ of the first member 20 is at least twenty five percent (25%) greater than the length L₂ of the second member 30. For example, if the second member 30 is two inches (2.0 in.) in length, the first member 20 is two and three-quarters inches (2.75 in.) in length. In some embodiments, a ratio of the length of the first member to the length of the second member is at least about 1.375.

In the illustrated embodiment, and as shown specifically in FIG. 6, each member 20, 30 has a substantially rectangular shape with rounded corners and a substantially constant width W₁, W₂ along its length. For example, in some embodiments, the width W₁, W₂ of each member 20, 30 is at least about two inches (2.0 in.).

As illustrated in FIGS. 1, 4 and 5, the jaw portion 24 of the first member 20 includes a plurality of storm panel-gripping teeth 50, and the jaw portion 34 of the second member 30 has a smooth surface. The teeth 50 of the first panel jaw portion 24 are configured to grip a storm panel P, for example, as illustrated in FIGS. 4-6. The smooth jaw portion 34 of the second member is configured to engage a window frame F (or other structural element adjacent to a window to be protected by storm panel P) without causing any damage to the window frame F (or other structural element).

In the illustrated embodiment, the storm panel-gripping teeth 50 are a plurality of parallel, spaced-apart ridges. However, the teeth 50 can have various configurations, and there can be various numbers of teeth 50.

In some embodiments, the manually grippable portion 22, 32 of each member 20, 30 includes a coating of resilient/tactile material (e.g., natural rubber, synthetic rubber, and silicone) 60 that facilitates gripping by a user's hand. In some embodiments, the jaw portion 34 of the second member that is configured to engage a window frame F (or other structural element adjacent to a window to be protected by storm panel P) includes a coating of resilient material 60 for protection of the frame or other structural element. An exemplary resilient/tactile material is Neoprene, available from E. I. du Pont de Nemours and Company, Wilmington, Del.

In some embodiments, the first and second members 20, 30 are formed from a rigid material, such as metal. An exemplary, metal is galvanized metal. However, various types of metals, as well as various other rigid materials, may be utilized. The first and second members 20, 30 may be formed via know molding and/or machining techniques. Moreover, if formed from polymeric material, the first and second members 20, 30 may be molded using known molding techniques including, but not limited to, injection molding, blow molding, compression molding, etc.

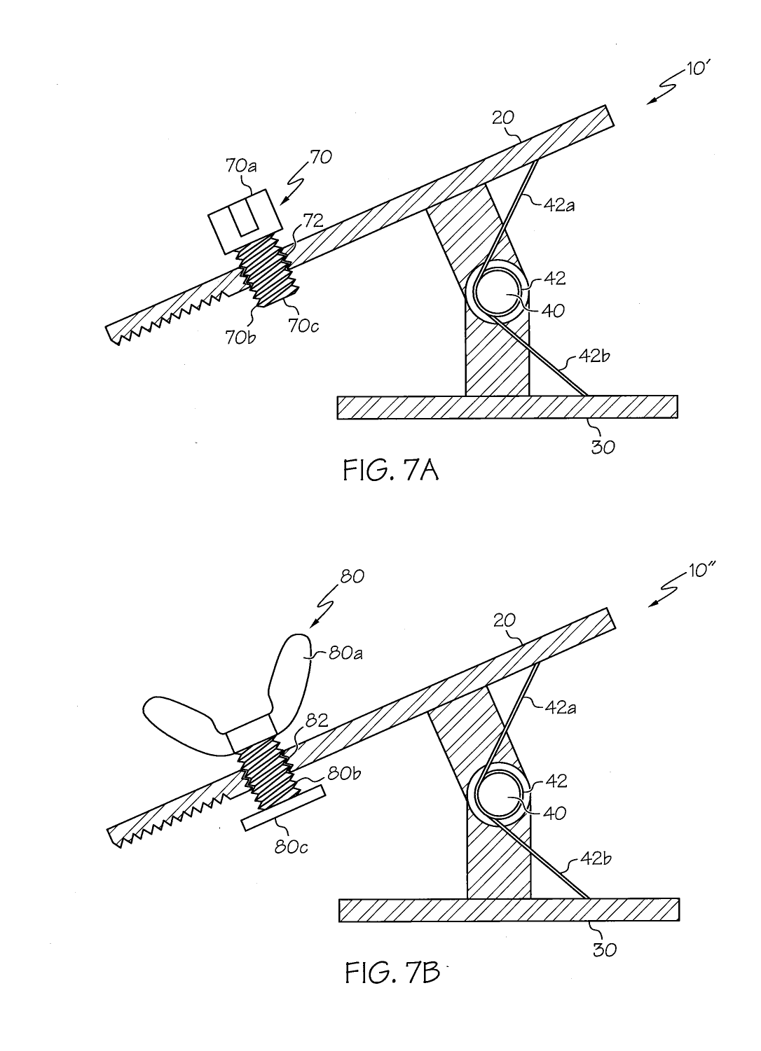

FIGS. 7A and 7B are cross-sectional side views of storm panel retaining clamps 10′ and 10″, according to other embodiments of the present invention. The clamp 10′ illustrated in FIG. 7A is similar to the clamp 10 described above and illustrated in FIG. 1. The clamp 10′ includes a set screw 70 threadingly secured to a threaded bore 72 formed in the rigid member 20. The set screw 70 has an exposed end 70a and a threaded body portion 70b that is threadingly engaged with the threaded bore 72. The exposed end 70a is configured to be engaged by a tool, such as a hex drive, screwdriver, etc., so as to rotate the set screw 70, as would be understood by those skilled in the art. The purpose of the set screw 70 is for the distal free end 70c thereof to engage and at least partly penetrate a storm panel P (e.g., P, FIG. 4). This penetration by the distal free end 70c of the set screw 70 enhances the gripping ability of the retaining clamp 10′.

The clamp 10″ illustrated in FIG. 7B is similar to the clamp 10 described above and illustrated in FIG. 1. The clamp 10″ includes a set screw 80 threadingly secured to a threaded bore 82 formed in the rigid member 20. The illustrated set screw 80 has an exposed end 80a in the shape of a wing nut and a threaded body portion 80b that is threadingly engaged with the threaded bore 82. The wing nut end 80a is configured to be gripped by a user so as to rotate the set screw 80, as would be understood by those skilled in the art. The purpose of the set screw 80 is for the distal free end 80c thereof to engage and at least partly penetrate a storm panel P (e.g., P, FIG. 4). This penetration by the distal free end 80c of the set screw 80 enhances the gripping ability of the retaining clamp 10″.

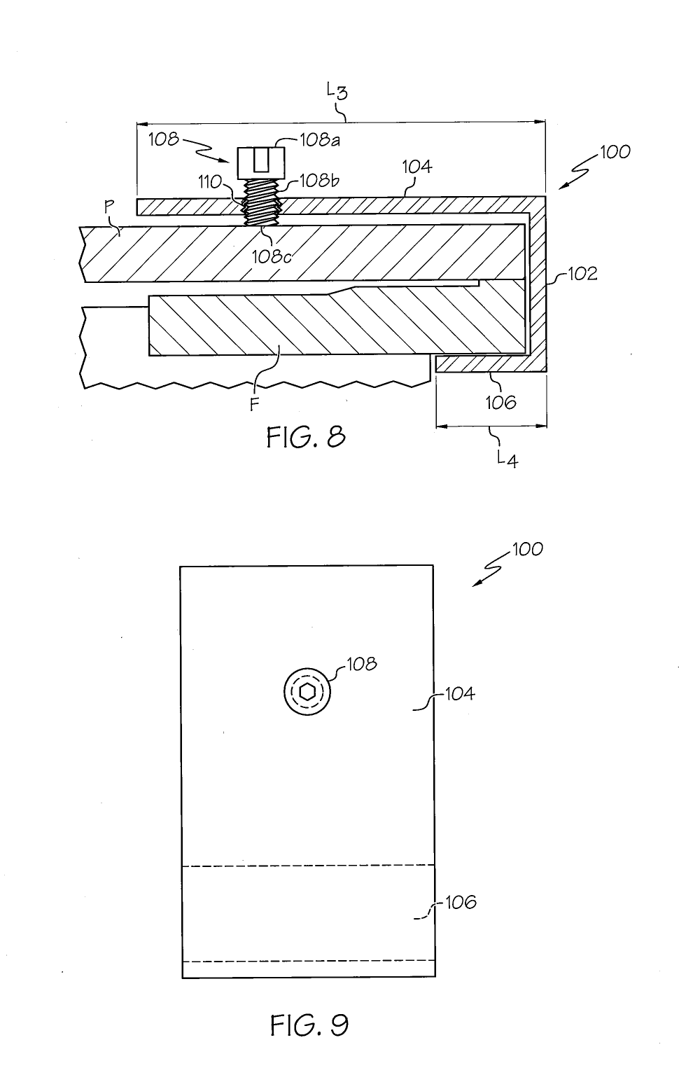

Referring now to FIGS. 8 and 9, a clamp 100 for securing storm panels (e.g., OSB panels, plywood panels, etc.) to windows of a house or building (e.g., a house or building at the beach), according to some embodiments of the present invention, is illustrated. A plurality of the clamps 100 are used to removably secure a storm panel P to a window of a house/building. Typically, four or more clamps are utilized.

The illustrated clamp 100 includes a rear wall 102 and opposing, elongated first and second side walls 104, 106 extending outwardly from the rear wall 102 in adjacent, spaced-apart relationship. A locking member 108 (e.g., a set screw, etc.) is threadingly secured to the first wall 104 and is configured to retain the clamp 100 in an installed position when a storm panel P and edge of a window frame F (or other structural element adjacent to a window to be protected by storm panel P) are positioned between the first and second walls. The locking member 108 has an exposed end 108a and a threaded body portion 108b that is threadingly engaged with a threaded bore 110 in the first side wall 104. The exposed end 108a is configured to be engaged by a tool, such as a hex drive, screwdriver, etc., so as to rotate the locking member 108, as would be understood by those skilled in the art. In other embodiments, the locking member 108 can have an exposed free end that can be manipulated by hand, such as the wing nut configuration illustrated in FIG. 7B. The purpose of the locking member 108 is for the distal free end 108c thereof to engage and at least partly penetrate a storm panel P. This penetration by the distal free end 108c of the locking member 108 secures the clamp 100 in an installed position.

In the illustrated embodiment, the first wall 104 has a first length L₃ and the second wall 106 has a second length L₄ that is shorter than the first length. In some embodiments, the first length L₃ is at least twenty five percent (25%) greater than the second length L₄.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the teachings and advantages of this invention. Accordingly, all such modifications are intended to be included within the scope of this invention as defined in the claims. The invention is defined by the following claims, with equivalents of the claims to be included therein.

That which is claimed is:

1. A storm panel retaining clamp, comprising:
a pair of opposed, first and second elongated members, each member comprising a first end including a manually grippable portion and a second end, opposite the first end, including a jaw portion, wherein the first member has a first length and the second member has a second length that is shorter than the first length;
a pivot pin connecting the members between the first and second ends thereof; and
a biasing element configured to urge the jaw portions toward each other.

2. The clamp of claim 1, wherein the jaw portion of the first member comprises a plurality of storm panel-gripping teeth, and wherein the jaw portion of the second member comprises a smooth surface.

3. The clamp of claim 1, wherein the plurality of storm panel-gripping teeth comprises a plurality of parallel, spaced-apart ridges.

4. The clamp of claim 1, wherein the biasing element comprises a spring having opposed legs bearing against corresponding inner surfaces of the first ends of the first and second members.

5. The clamp of claim 1, wherein the biasing element may develop a minimum torque of about 1.40 lbs.

6. The clamp of claim 1, wherein the biasing element comprises a spring coiled around the pivot pin.

7. The clamp of claim 1, wherein the first length is at least twenty five percent (25%) greater than the second length.

8. The clamp of claim 1, wherein a ratio of the first length to the second length is at least 1.375.

9. The clamp of claim 1, wherein the second length is at least about two inches (2.0 in.) and the first length is at least about two and three-quarters inches (2.75 in.), and wherein a width of each member is at least about two inches (2.0 in.).

10. The clamp of claim 1, wherein each member has a substantially constant width along its length.

11. The clamp of claim 1, wherein each member has a substantially rectangular shape with rounded corners.

12. The clamp of claim 1, wherein the manually grippable portion of each member comprises a coating of tactile material that facilitates gripping by a user's hand.

13. The clamp of claim 1, wherein the second member jaw portion comprises a coating of resilient material.

14. The clamp of claim 1, further comprising a locking member threadingly secured to the jaw portion of the first member and configured to retain the clamp in an installed position when a storm panel and edge of a window frame are positioned between the jaw portion of the first member and the jaw portion of the second member.

15. A method of securing a storm panel to a window of a structure, the method comprising:
covering a window with a storm panel; and
clamping edge portions of the storm panel to a frame of the window with a plurality of clamps, wherein each clamp comprises:
a pair of opposed, first and second elongated members, each member comprising a first end including a manually grippable portion and a second end, opposite the first end, including a jaw portion, wherein the first member has a first length and the second member has a second length that is shorter than the first length;
a pivot pin connecting the members between the first and second ends thereof; and
a biasing element configured to urge the jaw portions toward each other.

16. The method of claim 15, wherein the jaw portion of the first member comprises a plurality of storm panel-gripping teeth, and wherein the jaw portion of the second member comprises a smooth surface.

17. The method of claim 15, wherein the first length is at least twenty five percent (25%) greater than the second length.

18. The method of claim 15, wherein the manually grippable portion of each member comprises a coating of tactile material that facilitates gripping by a user's hand.

19. The method of claim 15, wherein the second member jaw portion comprises a coating of resilient material.

20. A storm panel retaining clamp, comprising:
a rear wall;
opposing, elongated first and second side walls extending outwardly from the rear wall in adjacent, spaced-apart relationship, wherein the first wall has a first length and the second wall has a second length that is shorter than the first length; and
a locking member threadingly secured to the first wall and configured to retain the clamp in an installed position when a storm panel and edge of a window frame are positioned between the first and second walls.

21. The clamp of claim 20, wherein the first length is at least twenty five percent (25%) greater than the second length.
